(19) United States
(12) Patent Application Publication
(10) Pub. No.: US 2024/0342796 A1
(43) Pub. Date: Oct. 17, 2024

(54) A POWDER PRODUCTION SYSTEM

(71) Applicant: TUSAS- TURK HAVACILIK VE UZAY SANAYII ANONIM SIRKETI, Kahramankazan/Ankara (TR)

(72) Inventor: Sertac ALTINOK, Kahramankazan/Ankara (TR)

(21) Appl. No.: 18/701,517

(22) PCT Filed: Oct. 11, 2022
(86) PCT No.: PCT/TR2022/051118

§ 371 Date: Apr. 15, 2024

(30) Foreign Application Priority Data
Oct. 19, 2021 (TR) 2021/016229

(51) Int. Cl. B22F 9/14; B22F 9/08; B33Y 70/00

(52) U.S. Cl. CPC B22F 9/14; B22F 9/082; B22F 2009/0836; B33Y 70/00

(57) ABSTRACT

This invention relates to more than one powder (T) suitable for use in a powder bed additive manufacturing method in a user-predetermined amount, a primary material (M) suitable to be brought into powder (T) form and having a user-predetermined composition content, a secondary material (N) with a composition content that is almost entirely different from that of the primary material (M), more than one waste gas (G) that is released when the primary material (M) and the secondary material (N) are brought into a powder (T) form and that is a waste product, at least one feeding unit (2) enabling the primary material (M) and the secondary material (N) to be fed, a first transmission line (3) into which the primary material (M) and the secondary material (N) are fed by means of the feeding unit (2), at least one plasma torch (4) enabling a powder (T) to be obtained from the primary material (M) and the secondary material (N) fed therein by means of the first transmission line (3) using a plasma atomization method, at least one powder composition meter (501) acquiring the composition content data of the powder (T).

This invention relates to a powder production system for powders suitable for use in additive manufacturing.

The additive manufacturing method for structural components for air and space vehicles or in other sectors enables designers to produce complex geometric parts of geometry that cannot be produced with conventional production methods. The flexible design provided by the additive manufacturing method to the designers makes it possible to produce high-strength and low-weight parts, i.e. parts with higher specific strength values. The properties of the powder material such as the composition content, particle structure, microstructure directly affect the part mechanics and constitute a limit that the designers have to consider in their part designs. The additive manufacturing method is made possible by combining the powders suitable for additive manufacturing with each other layer by layer and in this context, the development studies for the powders suitable for use in additive manufacturing have been continuing.

The United States patent document U.S. Pat. No. 20,060,096417, which is included in the known state of the art, describes the production method of aluminum and similar metal powders by a plasma arc atomization method. For powder production, plasma arc gas is transferred to an input material so that the solid feed material is evaporated and then cooled down to provide powder production. The system performs a compositional analysis in order to ensure that the chemical composition of the powder obtained is in line with the requirements. Compositional analyses such as surface area analysis, XPS, DSC are performed and it is examined as to which elements are contained in the powder obtained and analyzed compositionally.

Thanks to a powder production system developed with this invention, a powder production is provided which is suitable for use in a powder bed additive manufacturing method and has a user-determined compositional content.

Another object of the present invention is to provide a powder production system which is suitable for use in a powder bed additive manufacturing method and which, as a closed system, receives feedback from the production of additive manufacturing powders.

The powder production system realized to achieve the object of the invention and defined in the first claim and the other claims dependent thereon comprises more than one powder that can be used in a powder bed layered manufacturing method, a primary material made into powder form and having an elemental content for each user-determined element, a secondary material with a compositional content that is different from that of the primary material, more than one waste gas that result from the primary material and the secondary material during powder production and that is a waste gas to be discharged, at least one feeding unit enabling the primary material and the secondary material to be fed to a first transmission line, the first transmission line into which the primary material and the secondary material are fed by means of the feeding unit, at least one plasma torch enabling a powder to be produced from the primary material and the secondary material fed therein by means of the primary transmission line using a plasma atomization method, at least one powder composition meter measuring the elemental content data of each element of the powder.

In the powder production system of the invention, there are at least one waste gas composition meter measuring the elemental content data of each element of the waste gas, at least one composition meter measuring the elemental content data of the powder and the waste gas, at least one control unit enabling the relative feeding rates of the primary material and the secondary material to be varied by means of the feeding unit in order to equalize the elemental content data of the powder and the waste gas measured by the composition meter to a user-selected target elemental content data of the powder and the waste gas.

In an embodiment of the invention, in the powder production system, there is control unit comparing the amounts converted from the primary material and secondary material into powder and waste gas to user-predetermined target elemental content of powder and waste gas for each element based on the law of conservation of mass using the elemental content data of the waste gas and powder, and varying the relative feeding rates of the primary material and the secondary material and the variables such as the plasma torch's torch temperature, cooling temperature, cooling rate, independently or in the same time period according to the comparison performed.

In an embodiment of the invention, in the powder production system, there are a second transmission line enabling the transfer of powders produced in the plasma torch, a first powder chamber in the second transmission line enabling the storage of powders produced in the plasma torch, at least one pump in the second transmission line enabling the powders to be transferred through the second transmission line, and at least one exhaust enabling the waste gases to be discharged out from the second transmission line.

In one embodiment of the invention, in the powder production system, there is control unit enabling the primary material and the secondary material to be fed through the first transmission line to the plasma torch by means of the feeding unit, bring the primary material and the secondary material into a powder form using a plasma atomization method in the plasma torch, measure the elemental content data of each element of the powder and waste gas by means of the powder composition meter and the waste gas composition meter and transmit the measured elemental content data to the control unit, compare the elemental content data of each element of the powder and the waste gas as transferred from the composition meter to the user-determined ideal elemental content data of each element of the powder and waste gas in the control unit, vary the relative feeding rates of the primary material and the secondary material by means of the feeding unit based on this comparison so that they are approximated to user-selected target elemental content data of the powder.

In an embodiment of the invention, in the powder production system, there are first powder chamber located in the second transmission line enabling the storage of the powders of macro-, micro- or nano-order sizes as predetermined by a user, a second powder chamber located in the second transmission line enabling the storage of the powders of higher-order sizes than the powders of user-determined macro-, micro- or nano-order sizes stored in the first powder chamber.

In an embodiment of the invention, in the powder production system, there is control unit enabling each production variable and powder output values generated by a machine learning method with real production data transmitted by the user to the control unit to be evaluated and the feeding rates of the primary material and secondary material to be varied by means of the feeding unit so that the elemental content of the powder is rapidly and completely approximated to user-determined elemental content data once powder production is started.

In an embodiment of the invention, in the powder production system, there is control unit enabling the user to feed more of that material with a lower production cost among the primary material and the secondary material to lower the production costs of the produced powders and accordingly varying the feeding rates of the primary material and secondary material.

In an embodiment of the invention, in the powder production system, there is composition meter detecting the elemental contents of inorganic materials of powders using X-ray fluorescence (XRF) method and transferring the detected elemental content data to the control unit for varying the feeding rates of the primary material and the secondary material relative to each other.

In an embodiment of the invention, in the powder production system, there is composition meter detecting the elemental contents of organic materials using inert gas fusion (IGF) based combustion method and transferring the detected elemental content values to the control unit for varying the feeding rates of the primary material and the secondary material relative to each other.

In an embodiment of the invention, in the powder production system, there is control unit varying the variables such as the plasma torch's plasma temperature, cooling temperature, cooling rate to fully equalize the elemental content data of each element of powder to user-predetermined elemental content values of each desired element of the powder and waste.

In an embodiment of the invention, in the powder production system, there is a first valve located in the second transmission line, first powder chamber and/or second powder chamber, enabling the separation and transfer of the target macro-, micro- or nano-order size powders to the relevant powder chamber with its perforated structure such that the produced powders which have not reached the target composition ratio are transferred to the respective powder chamber by allowing or blocking the passage of powders by means of the control unit.

In an embodiment of the invention, in the powder production system, there are at least a third transmission line in which there is a composition meter and through which only the amount of powder that is needed to take a test sample from the powders produced in the plasma torch is transmitted, at least one plasma torch valve which enables the transmission of a user-defined amount of powder to the third transmission line to take the test sample from the powder produced in the plasma torch and is brought to an open or closed position by means of the control unit.

In an embodiment of the invention, in the powder production system, there is at least one particle size meter located on the second transmission line, detecting the particle sizes of powders produced using a laser diffraction method and transferring the detected data to the control unit for changing the variables such as the feeding rates of the primary material and the secondary material and the plasma torch's plasma temperature, cooling rate.

In an embodiment of the invention, in the powder production system, there is a primary feeder which is a vibrating feeder or a screw disc feeder, enabling the one with a solid form from the primary material and/or the secondary material to be fed to the plasma torch by means of the primary transmission line.

In an embodiment of the invention, in the powder production system, there is a second feeder in the form of a peristaltic pump or a flow meter, enabling the one with a liquid or gas form from the primary material and/or the secondary material to be fed to the plasma torch by means of the primary transmission line.

The powder production system realized to achieve the object of the present invention is shown in the attached figures, wherein from these figures;

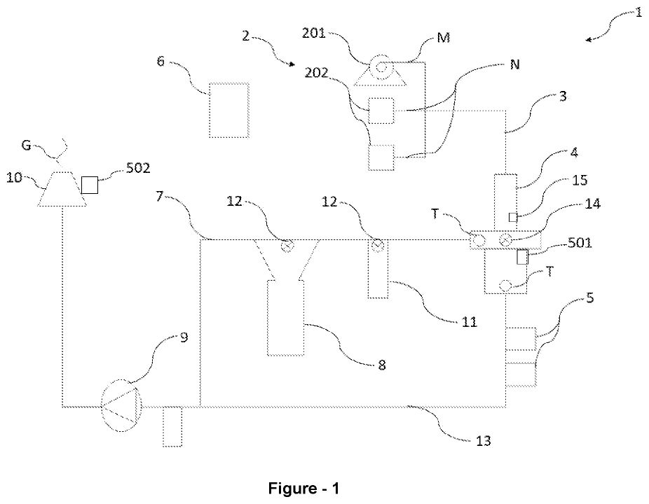

FIG. 1 is a schematic view of a powder production system.

All the parts illustrated in figures are individually assigned a reference numeral and the corresponding terms of these numbers are listed below.
1. Powder production system
2. Feeding unit
   201. Primary feeder
   202. Secondary feeder
3. First transmission line
4. Plasma torch
5. Composition meter
   501. Powder composition meter
   502. Waste gas composition meter
6. Control unit
7. Second transmission line
8. First powder chamber
9. Pump
10. Exhaust
11. Second powder chamber
12. First valve
13. Third transmission line
14. Plasma torch valve
15. Particle size meter
(T) Powder
(M) Primary material
(N) Secondary material
(G) Waste gas

Powder production system (1) comprises more than one powder (T) suitable for use in a powder bed additive manufacturing method in a user-predetermined amount, a primary material (M) suitable to be brought into powder (T) form and having a user-predetermined composition content, a secondary material (N) with a composition content that is almost entirely different from that of the primary material (M), more than one waste gas (G) that is released when the primary material (M) and the secondary material (N) are brought into a powder (T) form and that is a waste product, at least one feeding unit (2) enabling the primary material (M) and the secondary material (N) to be fed, a first transmission line (3) into which the primary material (M) and the secondary material (N) are fed by means of the feeding unit (2), at least one plasma torch (4) enabling a powder (T) to be obtained from the primary material (M) and the secondary material (N) fed therein by means of the first transmission line (3) using a plasma atomization method, at least one powder composition meter (501) acquiring the composition content data of the powder (T) (FIG. 1).

The powder production system (1) of the invention comprises at least one waste gas composition meter (502) that acquires the composition content data of the waste gas (G), at least one composition meter (5) that acquires the composition content data of the powder (T) and waste gas (G), at least one control unit (6) enabling the feeding rates of the primary material (M) and the secondary material (N) to be changed by means of the feeding unit (2) in order to almost completely approximate the composition content data of the powder (T) and waste gas (G) obtained from the composition meter (5) to the user-determined target composition content data of the powder (T) and waste gas (G). The powder composition meter (501) can be located in the plasma torch (4), the first transmission line (3) or the second transmission line (7) (FIG. 1).

A plasma torch production method can be used for the production of powder (T) suitable for use in the powder bed additive manufacturing method. In the plasma torch production method, the primary material (M) and the secondary material (M), which can be in the form of a solid, liquid or gas and have a certain composition, are transmitted to the plasma torch (4) and after the primary material (M) and the secondary material (N) are raised to very high temperatures in the plasma torch (4) and brought into the plasma form, the plasma material is cooled rapidly under a high cooling effect and solidified in the form of a powder (T) and thus the powder (T) is produced. Since the primary material (M) and the secondary material (M), which can be in the form of a solid, liquid or gas and have only a certain composition, are fed into the plasma torch (4) at a constant feeding rate by means of the feeding unit (2), it is possible to produce a powder (T) with almost only one composition. If a user wants to produce a powder (T) with a different compositional content, the user is required to supply the primary materials (M) and secondary materials (N) in a vast number of compositional proportions, so both the production costs increase considerably and the production of a powder (T) with a wide range of compositional content cannot be realized. In addition to this, the user cannot not have sufficient information regarding the content of powder (T) generated while production is in progress, which increases the likelihood of the powder (T) produced to be discarded and reduces the user's control over the powder production system (1). Using the plasma atomization method as the production method of the powder (T) ensures that the obtained powders (T) are almost completely in a spherical form (FIG. 1).

Thanks to the use of the composition meter (501) in the powder production system (1), elemental content analysis is performed on the powder (T) and waste gas (G) samples taken and the acquired data are sent to the control unit (6). The control unit (6) changes the feeding rates of the primary feeder (201) and the secondary feeder (202) by comparing the compositional content of each element in the powder (T) being produced and the compositional contents of each element targeted by the user, and ensures that the compositional content of the produced powder (T) is identical to the compositional content of each element targeted by the user. For example, if the compositional content of an element X in the produced powder (T) is lower than the compositional content of the element X targeted by the user, the control unit (6) increases the feeding rate of the primary feeder (201) or the secondary feeder (202) that supplies the element X. The control unit (6) enables the feeding rates of the primary feeder (201) and the secondary feeder (202) to be changed. Thanks to the capability that the different materials of the feeding unit (2) including the primary feeder (201) and the secondary feeder (202) are fed in a desired composition, the powder production system (1) can be realized that enables the primary material (M) and the secondary material (N) to be converted into a powder (T) with a composite material, radar absorbent material and/or thermal coating feature and a user-predetermined size and compositional content (FIG. 1).

In an embodiment of the invention, the powder production system (1) comprises a control unit (6) that compares the amounts converted from the primary material (M) and secondary material (N) to powder (T) and waste gas (G) for each element to the target composition content of the powder (T) and waste gas (G) determined by the user using the principle of mass conservation using the composition content data of the waste gas (G) and powder (T) and changes the feeding rates of the primary material (M) and secondary material (N) and the plasma torch (4) parameters simultaneously. For example, if the compositional content of an element X in the produced powder (T) is lower than the compositional content of the element X targeted by the user, the control unit (6) increases the feeding rate of the primary feeder (201) or the secondary feeder (202) that supplies the element X. The control unit (6) enables the feeding rates of the primary feeder (201) and the secondary feeder (202) to be changed (FIG. 1).

In an embodiment of the invention, the powder production system (1) comprises a second transmission line (7) enabling the transmission of powders (T) obtained in the plasma torch (4), a first powder chamber (8) located on the second transmission line (7), enabling the collection of powders (T) obtained in the plasma torch (4), at least one pump (9) located on the second transmission line (7) and enabling the powders (T) to be transmitted along the second transmission line (7), and at least one exhaust (10) enabling waste gases (G) to be discharged from the second transmission line (7). The integration of the waste gases (G) discharged from the exhaust (10) into the powder production system (1) contributes to the operation of the powder production system (1) as a closed system. An additional feedback data is obtained for the powders (T) produced by measuring the compositional content of the waste gases (G) by means of the composition meter (501). The second transmission line (7) enables the powders (T) obtained in the plasma torch (4) to be transferred in the powder production system (1). With the obtained closed system, it is ensured that a feedback is obtained with the compositional content data of the powder (T) and waste gas (G) generated by the powder production system (1) and the powder production system (1) is enabled to be operated continuously. When the first powder chamber (8) is almost completely filled, the powders (T) are discharged from the first powder chamber (8) and are sent to a separate additive manufacturing device where a part production will be carried out. The discharging of the powders (T) from the first powder chamber (8) and/or the exchange of the first powder chamber (8) with another empty first powder chamber (8) can be done manually by the respective technician or automatically by means of a robot. The pump (9) provides the energy required for the transmission of the powders (T) within the powder production system (1) (FIG. 1).

In an embodiment of the invention, the powder production system (1) comprises control unit (6) enabling the primary material (M) and the secondary material (N) to be fed by means of the feeding unit (2) to the plasma torch (4) through the first transmission line (3), to convert the primary material (M) and the secondary material (N) into the form of powder (T) by a plasma atomization method in the plasma torch (4), obtain the composition content data of the powder (T) and waste gas (G) by means of the powder composition meter (501) and the waste gas composition meter (502), and transfer the obtained composition content data to the control unit (6), compare the composition content data of the powder (T) and waste gas (G) transferred from the composition meter (5) to user-predetermined target composition content data of the powder (T) and waste gas (G) in the control unit (6), vary the feeding rates of the primary material (M) and the secondary material (N) by means of the feeding unit (2) based on this comparison so that the powder (T) is almost exactly equalized to user-determined target composition content data (FIG. 1).

In an embodiment of the invention, the powder production system (1) comprises first powder chamber (8) located on the second transmission line (7) and enabling the collection of powders (T) of macro-, micro— or nano-order sizes as determined by a user, a second powder chamber (11) located on the second transmission line (7), enabling the collection of powders (T) of higher-order sizes than the powders (T) of user-determined macro-, micro— or nano-order sizes collected in the first powder chamber (8). The user makes the necessary modifications on the spherical valve, perforated sieve structure and vacuum magnitude of the first powder chamber (8) and/or the second powder chamber (11) and enables the powders (T) of a desired-order size from the macro-, micro— or nano-order sized powders (T) to be collected in the first powder chamber (8) or in the second powder chamber (11). The second powder chamber (11) can be located in the plasma torch (4) and/or the second transmission line (7) in different alternatives of the invention (FIG. 1).

In an embodiment of the invention, the powder production system (1) comprises control unit (6) that enables each production parameter and output generated using a machine learning method with data previously defined by user in the control unit (6) to be evaluated and the feeding rates of the primary material (M) and the secondary material (N) to be changed by means of the feeding unit (2) so that the composition of the powder (T) is almost entirely efficiently approximated to a user-predetermined composition content. Thanks to the use of machine learning in the control unit (6), anytime the powder production system (1) carries out powder (T) production, the powder production system (1) uses the data obtained from the previous production experiences so that immediately after the powder production system (1) starts to produce powder (T), it is enabled that the produced powder's (T) compositional content approximates very rapidly to the user-determined/targeted powder (T) compositional content and reaches the targeted value (FIG. 1).

In an embodiment of the invention, the powder production system (1) comprises control unit (6) that enables the user to change the feeding rates of the primary material (M) and the secondary material (N) for reducing the cost of the powder (T) produced. (FIG. 1).

In an embodiment of the invention, the powder production system (1) comprises composition meter (5) measuring the composition of inorganic material of powders (T) by an X-ray fluorescence (XRF) method and transmitting the obtained measurement data to the control unit (6) for varying the feeding rates of the primary material (M) and the secondary material (N) (FIG. 1).

In an embodiment of the invention, the powder production system (1) comprises composition meter (5) measuring the composition of organic material by an inert gas fusion (IGF) based combustion method and transmitting the obtained measurement data to the control unit (6) for varying the feeding rates of the primary material (M) and the secondary material (N) (FIG. 1).

In an embodiment of the invention, the powder production system (1) comprises control unit (6) that changes the parameters of the plasma torch (4) so that the composition content data of the powder (T) and waste gas (G) are almost entirely approximated to the target composition content data of the user-determined powder (T) and waste gas (G). Since all of the parameters such as the plasma torch's (4) plasma temperature, cooling temperature and cooling rate affect the properties of the powder (T), the control unit (6) can change all the parameters of the plasma torch (4) according to the obtained data (FIG. 1).

In an embodiment of the invention, the powder production system (1) comprises a first valve (12) located on the second transmission line (7), the first powder chamber (8) and/or the second powder chamber (11), enabling the desired macro-, micro— or nano-sized powders (T) to be separated and transmitted to the relevant powder chamber with its sieve structure, and by being brought to an open or closed position by the control unit (6), enabling the powders (T) that have not reached the target composition ratio to be transmitted to the respective powder chamber. When the powder production system (1) starts to operate, the first powder chamber (8) can be used as a waste chamber at the beginning of production since the produced powders (T) will not have the compositional content targeted by the user. As of the time point when the powder (T) produced is almost exactly the same as the compositional content targeted by the user, the first powder chamber (8) containing the powders (T) with an undesired composition is replaced with a new one so that the newly installed first powder chamber (8) will consist of powders (T) with the compositional content targeted by the user.

In order for said process to be carried out, the opening and closing feature of the first valve (12) is used. While the first valve (12) enables the collection of macro-sized powders (T) into the relevant powder chamber when it has a structure that will allow the passage of only macro-sized powders (T) predetermined by the user, it will enable the micro—and nano-order powders (T) which are smaller than the macro-order size determined by the user to proceed on the second transmission line (7) (FIG. 1).

In an embodiment of the invention, the powder production system (1) comprises at least one third transmission line (13) on which the composition meter (5) is located and to which only the amount of powder (T) required to take a sample from the powders (T) obtained in the plasma torch (4) is transferred, at least one plasma torch valve (14) that enables a user-predetermined amount of powder (T) to be transferred to the third transmission line (13) to take a sample from the powder (T) obtained in the plasma torch (4) and is triggered by the control unit (6). Compositional content analysis is performed by means of composition meter (501) from the powders (T) transferred to the third transmission line (13) for sampling only from the plasma torch valve (14) and feedback data is obtained about the compositional content of the produced powder (T). Obtaining the sampled powders (T) from a separate third transmission line (13) enables the powder production system (1) to be effectively operated (FIG. 1).

In an embodiment of the invention, the powder production system (1) comprises at least one particle size meter (15) located on the second transmission line (7), measuring the particle sizes of the powder (T) using a laser diffraction method and transmitting the measurement data to the control unit (6) for changing the feeding rates of the primary material (M) and the secondary material (N) and/or the plasma torch (4) parameters. Measuring the particle size of the powder (T) enables the user to make sure that the desired global form is obtained from the powder and, when it becomes necessary, to obtain the user-determined particle size by changing the parameters of the powder production system (1) such as the plasma torch (4) temperature and cooling, the feeding rates of the primary feeder (201) and the secondary feeder (202) (FIG. 1).

In an embodiment of the invention, the powder production system (1) comprises a primary feeder (201), which is a vibrating feeder or a screw disc feeder, enabling the one that is in a solid form from the primary material (M) or the secondary material (N) to be fed (FIG. 1).

In an embodiment of the invention, the powder production system (1) comprises a second feeder (202), which is a peristaltic pump or a flow meter, enabling the one that is in the form of a liquid or a gas from the primary material (M) or the secondary material (N) to be fed (FIG. 1).

1. A powder production system (1) for more than one powder (T) suitable for a powder bed additive manufacturing method in a user-predetermined amount, comprising:
a primary material (M) suitable to be brought into powder (T) form and having a user-predetermined composition content,
a secondary material (N) having a composition content that is almost entirely different from that of the primary material (M), more than one waste gas (G) that is released when the primary material (M) and the secondary material (N) are brought into a powder (T) form and that is a waste product,
at least one feeding unit (2) enabling the primary material (M) and the secondary material (N) to be fed, a first transmission line (3) into which the primary material (M) and the secondary material (N) are fed by means of the feeding unit (2),
at least one plasma torch (4) enabling a powder (T) to be obtained by means of a plasma atomization method from the primary material (M) and the secondary material (N) fed therein through the first transmission line (3),
at least one powder composition meter (501) acquiring the composition content data of the powder (T),
at least one waste gas composition meter (502) acquiring the composition content data of the waste gas (G),
at least one composition meter (5) acquiring the composition content data of the powder (T) and waste gas (G), and
at least one control unit (6) enabling the feeding rates of the primary material (M) and the secondary material (N) to be changed by means of the feeding unit (2) to almost completely approximate the composition content data of the powder (T) and waste gas (G) obtained from the composition meter (5) to the user-determined target composition content data of the powder (T) and waste gas (G).

2. The powder production system (1) according to claim 1, wherein the control unit (6) compares the amounts converted from the primary material (M) and secondary material (N) into powder (T) and waste gas (G) for each element to the user-determined target composition content of the powder (T) and waste gas (G) based on the principle of mass conservation using the composition content data of the waste gas (G) and powder (T) and changes the feeding rates of the primary material (M) and secondary material (N) and the plasma torch (4) parameters simultaneously.

3. The powder production system (1) according to claim 1, comprising a second transmission line (7) enabling the transmission of the powders (T) obtained in the plasma torch (4), a first powder chamber (8) located on the second transmission line (7) enabling the collection of the powders (T) obtained in the plasma torch (4), at least one pump (9) located on the second transmission line (7) and enabling the powders (T) to be transmitted along the second transmission line (7), and at least one exhaust (10) enabling the waste gases (G) to be discharged from the second transmission line (7).

4. The powder production system (1) according any to claim 1, wherein the control unit (6) enables the primary material (M) and the secondary material (N) to be fed through the first transmission line (3) to the plasma torch (4) by means of the feeding unit (2), the primary material (M) and the secondary material (N) to be converted into the form of powder (T) by a plasma atomization method in the plasma torch (4), the composition content data of the powder (T) and waste gas (G) to be obtained by means of the powder composition meter (501) and the waste gas composition meter (502) and the obtained composition content data to be transmitted to the control unit (6), the composition content data of the powder (T) and waste gas (G) transferred from the composition meter (5) to be compared to user-predetermined target composition content data of the powder (T) and waste gas (G) in the control unit (6), the feeding rates of the primary material (M) and the secondary material (N) to be changed by means of the feeding unit (2) based on this comparison made, such that the powder (T) is almost exactly equalized to user-determined target composition content data.

5. The powder production system (1) according to claim 1, comprising a first powder chamber (8) located on the second transmission line (7) and enabling the powders (T) of a user-determined macro-, micro—or nano-order size to be collected, and a second powder chamber (11) located on the second transmission line (7) enabling the powders (T) of almost larger sizes than the powders (T) collected in the first powder chamber (8) to be collected in itself.

6. The powder production system (1) according to claim 1, wherein the control unit (6) a enables ny production parameter and outputs generated using a machine learning method with the data previously defined by the user in the control unit (6) to be evaluated and the feeding rates of the primary material (M) and the secondary material (N) to be changed by means of the feeding unit (2), enables the powder (T) composition to be almost exactly approximated to the user-predetermined composition content data.

7. The powder production system (1) according to claim 1, wherein the control unit (6) enables the user to change the feeding rates of the primary material (M) and the secondary material (N) for reducing the cost of the powder (T) produced.

8. The powder production system (1) according to claim 1, wherein the composition meter (5) measures the inorganic material composition of powders (T) by an X-ray fluorescence (XRF) method and transmits the obtained measurement data to the control unit (6) for varying the feeding rates of the primary material (M) and the secondary material (N).

9. The powder production system (1) according to claim 1, wherein the composition meter (5) measures the organic material composition by an inert gas fusion (IGF) based combustion method and transmits the obtained measurement data to the control unit (6) for varying the feeding rates of the primary material (M) and the secondary material (N).

10. The powder production system (1) as claimed in claim 1, wherein the control unit (6) changes the parameters of the plasma torch (4) so that the composition content data of the powder (T) and waste gas (G) are almost entirely approximated to user-determined target composition content data of the powder (T) and waste gas (G).

11. The powder production system (1) as claimed in claim 4, comprising a first valve (12) located on the second transmission line (7), the first powder chamber (8) and/or the second powder chamber (11) for enabling the desired macro-, micro— or nano-sized powders (T) to be separated and transmitted to the relevant powder chamber by means of its sieve structure, and by being brought to an open or closed position by the control unit (6), enabling the powders (T) that have not reached the target composition ratio to be transmitted to the relevant powder chamber.

12. The powder production system (1) as claimed in claim 1, comprising at least one third transmission line (13) on which the composition meter (5) is located and to which only the amount of powder (T) that is required to take a sample from the powders (T) obtained in the plasma torch (4) is transferred, at least one plasma torch valve (14) that enables a user-predetermined amount of powder (T) to be transferred to the third transmission line (13) to take a sample from the powder (T) obtained in the plasma torch (4) and is triggered by the control unit (6).

13. The powder production system (1) as claimed in claim 1, comprising at least one particle size meter (15) located on the second transmission line (7), measuring the particle sizes of the powder (T) using a laser diffraction method and transmitting the measurement data to the control unit (6) for changing the feeding rates of the primary material (M) and the secondary material (N) and/or the plasma torch (4) parameters.

14. A powder production system (1), comprising a primary feeder (201), which is a vibrating feeder or a screw disc feeder, enabling the one that is in a solid form from the primary material (M) or the secondary material (N) to be fed.

15. The powder production system (1) as claimed in claim 1, comprising a secondary feeder (202), which is a peristaltic pump or a flow meter, enabling the one that is in the form of a liquid or a gas from the primary material (M) or the secondary material (N) to be fed.
